(19) United States
(12) Patent Application Publication
(10) Pub. No.: US 2026/0272759 A1
(43) Pub. Date: Sep. 17, 2026

(54) MASSAGE MECHANISM WITH ADJUSTMENT FUNCTION AND MASSAGER

(71) Applicant: Xiamen Xuemi Technology Co., Ltd., Xiamen (CN)

(72) Inventor: Fei Zhan, Zhumadian (CN)

(21) Appl. No.: 19/673,632

(22) Filed: May 11, 2026

(30) Foreign Application Priority Data
Dec. 31, 2025 (CN) 202512047985.4
Dec. 31, 2025 (CN) 202522831052.X

(51) Int. Cl. A61H 7/00

(52) U.S. Cl. CPC A61H 7/007; A61H 2007/009; A61H 2201/0242; A61H 2201/1215; A61H 2201/1463; A61H 2201/149; A61H 2201/5066; A61H 2201/5069; A61H 2201/5071; A61H 2201/5082

(57) ABSTRACT

Provided are a massage mechanism with adjustment function and a massager. The massage mechanism with adjustment function includes an adjusting driving unit, an adjusting screw rod, and at least one push block. An output shaft of the adjusting driving unit is connected to the adjusting screw rod, the push block is threaded with the adjusting screw rod and is provided with a guide part. There are two or more sets of massage components, which include an installation seat and a massage head provided on the installation seat. A sliding groove is provided on one side of the installation seat near the adjustment component, and the sliding groove is inserted into the guide part. The adjusting drive unit drives the adjusting screw rod to rotate, and the push block pushes the installation seat to move, to adjust a position of the massage component.

### CROSS-REFERENCE TO RELATED APPLICATIONS

This application claims priority to Chinese Patent Application No. 202512047985.4, filed on December 31, 2025 and Chinese Patent Application No. 202522831052.X, filed on December 31, 2025. Both are hereby incorporated by reference in their entireties.

### TECHNICAL FIELD

The present disclosure relates to the field of massage equipment technologies, and in particular, to a massage mechanism with adjustment function and a massager.

### BACKGROUND

At present, most of the back and neck fixed massagers on the market have fixed massage heads or only support limited manual coarse adjustment. Due to the differences in body shape among different users and the varying massage needs of different parts of the same user, this design makes it difficult to quickly adjust the massage head to the optimal position, resulting in insufficient flexibility and adaptability, leading to poor user experience.

Therefore, it is necessary to provide a massage mechanism with adjustment function and a massager to solve the technical problem of poor user experience caused by the inability of existing massage heads to be quickly adjusted to the optimal position, insufficient flexibility and adaptability, and varying massage needs for different body types of users and different parts of the same user.

To achieve the above objectives, in a first aspect, the present disclosure provides a massage mechanism with adjustment function, including:
an adjustment component, which includes an adjusting driving unit, an adjusting screw rod, and at least one push block, where an output shaft of the adjusting driving unit is connected to the adjusting screw rod, the push block is threaded with the adjusting screw rod, and a guide part is provided on the push block;
and two or more sets of massage components, where the massage components include an installation seat and a massage head provided on the installation seat, a sliding groove is provided on one side of the installation seat close to the adjustment component, and the sliding groove is inserted into the guide part and slidably connected with the guide part;
where the adjusting driving unit drives the adjusting screw rod to rotate, and the push block pushes the installation seat that cooperates with it to move and adjust a position of the massage component.

As an embodiment of the present disclosure, the massage component further includes a guide track, the guide track is arc-shaped, and the guide track is configured for the installation seat to slide and adjust a position of the installation seat along the guide track.

As an embodiment of the present disclosure, the adjusting screw rod is a bidirectional screw, and two ends of the adjusting screw rod have threads with opposite rotation directions;
there are two sets of push blocks, and there are two sets of massage components, each set of massage components corresponds to one push block;
the two push blocks are matched with the threads at two ends of the bidirectional screw and are configured to move towards or away from each other when the adjusting screw rod rotates and synchronously drive the two sets of massage components to approach or move away from each other.

As an embodiment of the present disclosure, it further includes two limit switches, the two limit switches are arranged corresponding to limit stroke positions of the two push blocks, and the two limit switches are electrically connected to a control terminal of the adjusting driving unit.

As an embodiment of the present disclosure, the adjusting screw rod is a unidirectional screw, and there is one push block;
there are two sets of massage components, one set of massage components is fixedly arranged, and the other set of massage components cooperates with the push block to adjust a distance between the two massage components.

As an embodiment of the present disclosure, the output shaft of the adjusting driving unit is connected to the adjusting screw rod through a worm gear transmission component, and the worm gear transmission component includes a worm shaft and a worm wheel, the worm shaft is connected to the output shaft of the adjusting driving unit, the worm wheel is fixedly sleeved on the adjusting screw rod and meshes with the worm shaft;
where the adjusting driving unit drives the worm shaft to rotate, drives the worm wheel to rotate, and thus drives the adjusting screw rod to rotate.

As an embodiment of the present disclosure, it further includes a rotating component, where the rotating component includes a rotating driving unit and a rotating screw rod, an output shaft of the rotating driving unit is connected to the rotating screw rod, there are two sets of massage components, and two ends of the rotating screw rod are respectively connected to the two sets of massage heads for transmission;
where the rotating driving unit drives the rotating screw rod to rotate and cause the two sets of massage heads to rotate.

As an embodiment of the present disclosure, the two ends of the rotating screw rod are connected to the massage head through a gear transmission component, and the gear transmission component includes a first gear, a second gear, and a third gear; the first gear meshes with the rotating screw rod, the second gear is coaxially arranged with the first gear, the third gear is coaxially arranged with the massage head on the installation seat, and the third gear meshes with the second gear;
where when the rotating screw rod rotates, it drives the first gear to rotate and drive the massage head to rotate through the second gear and the third gear.

To achieve the above objectives, in a second aspect, the present disclosure further provides a massager, including:
a shell;
the massage mechanism with adjustment function, and the massage mechanism with adjustment function is provided inside the shell.

As an embodiment of the present disclosure, the massager further includes a control mechanism, and the control mechanism includes a control main board, a battery, and a detection component; the control main board and the battery are provided in the shell, and the control main board is respectively connected to the massage mechanism with adjustment function, the battery, and the detection component for communication; the control main board is configured to control a movement of the adjusting driving unit based on a real-time detection of contact state information between the massage component and a human body by the detection component to adaptively adjust a position of the massage component.

As an embodiment of the present disclosure, the detection component includes a pressure sensor and a position sensor, where the pressure sensor is provided on a surface of the massage head for contact with the human body, and configured to detect a pressure value exerted by the massage head on the human body, and the position sensor is configured to detect a real-time position of the push block.

As an embodiment of the present disclosure, the massage component further includes a rotating joint connected to the massage head, the detection component further includes an attitude sensor configured to detect an angle of the massage head, and the control main board synchronously drives the rotating joint to adjust a pitch angle of the massage head when adjusting positions of the two sets of massage components, so as to fit a human body curve.

As an embodiment of the present disclosure, the detection component further includes a distance sensor for non-contact measurement of a distance between the massage head and a surface of the human body before the massage head contacts the human body.

As an embodiment of the present disclosure, the shell includes an upper shell and a lower shell that are matched with each other, the lower shell is provided with an accommodation chamber inside, the massage component is provided on the lower shell, and the adjusting driving unit, the control main board, and the battery are all provided in the accommodation chamber.

As an embodiment of the present disclosure, the lower shell is provided with a maintenance cover at a bottom of the accommodation chamber, and the maintenance cover is provided with a heat dissipation hole.

As an embodiment of the present disclosure, the control mechanism further includes a heat dissipation fan provided in the accommodation chamber, and the heat dissipation fan is connected to the control main board.

As an embodiment of the present disclosure, the detection component further includes a temperature sensor, and the temperature sensor is provided in the accommodation chamber, where the control main board is configured to detect a real-time temperature inside the accommodation chamber based on the temperature sensor to control an operation of the cooling fan.

Different from existing technologies, the above technical solution drives the adjusting screw rod to rotate by the adjusting driving unit, causing the push block that is threaded with it to produce horizontal displacement. The guide part on the push block slides and cooperates with the sliding groove of the installation seat, thereby directly converting a linear motion of the push block into a precise translation of the massage component. The mechanical transmission principle not only achieves continuous and smooth electric adjustment of the massage head position, enabling it to quickly adapt to different user body types and massage parts, but also has a compact structure and reliable transmission, thereby solving the problem of poor adjustment flexibility of traditional equipment.

### BRIEF DESCRIPTION OF DRAWINGS

The attached drawings are only used to illustrate the principles, implementation modes, applications, features, and effects of the specific embodiments and other related content of the present application, and cannot be considered as limitations on the present application.

FIG. 1 is a schematic structural diagram of a massager without a massage head according to an embodiment of the present application.

FIG. 2 is a schematic structural diagram of the massager according to an embodiment of the present application.

FIG. 3 is a schematic structural diagram of the massager when a maintenance cover being opened according to an embodiment of the present application.

FIG. 4 is an enlarged partial view of the massager according to an embodiment of the present application.

FIG. 5 is a schematic diagram of an internal structure of the massager according to an embodiment of the present application.

FIG. 6 is another schematic diagram of the internal structure of the massager according to an embodiment of the present application.

FIG. 7 is a schematic structural diagram of a massage mechanism according to an embodiment of the present application.

FIG. 8 is a schematic structural diagram of a massage component and an adjustment component that are cooperated in an embodiment of the present application.

Numeral reference: 1- shell, 11- upper shell, 111- installation hole, 112- motor heat dissipation hole, 12- lower shell, 121- accommodation chamber, 122- maintenance cover, 2- massage mechanism with adjustment function, 21- adjustment component, 211- adjusting driving unit, 212- adjusting screw rod, 213- push block, 2131- guide part, 214- worm gear transmission component, 2141- worm shaft, 2142- worm wheel, 22- massage component, 221- installation seat, 2211- sliding groove, 222- guide track, 23- rotating component, 231- rotating driving unit, 232- rotating screw rod, 233- gear transmission component, 2331- first gear, 2332- second gear, 2333- third gear, 3- control mechanism, 31- control main board, 32- battery.

### DESCRIPTION OF EMBODIMENTS

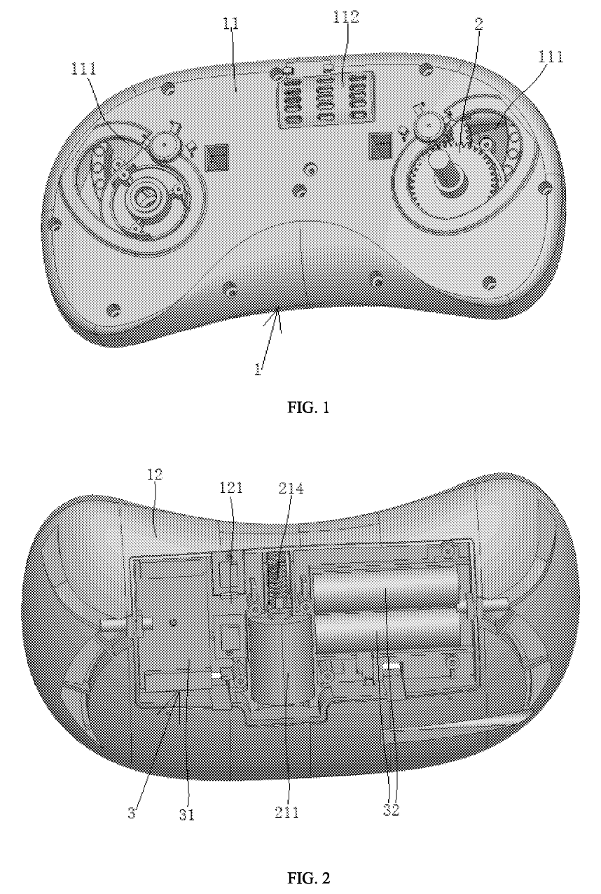

As shown in FIGS. 1 to 6, this embodiment relates to a massager, which includes a shell 1 and a massage mechanism with adjustment function 2. The massage mechanism with adjustment function 2 is provided inside the shell 1. This massager integrates the massage mechanism with adjustment function 2 to achieve multi-dimensional adjustment of a position and an angle of a massage head, to meet user needs and improve massage comfort and effectiveness.

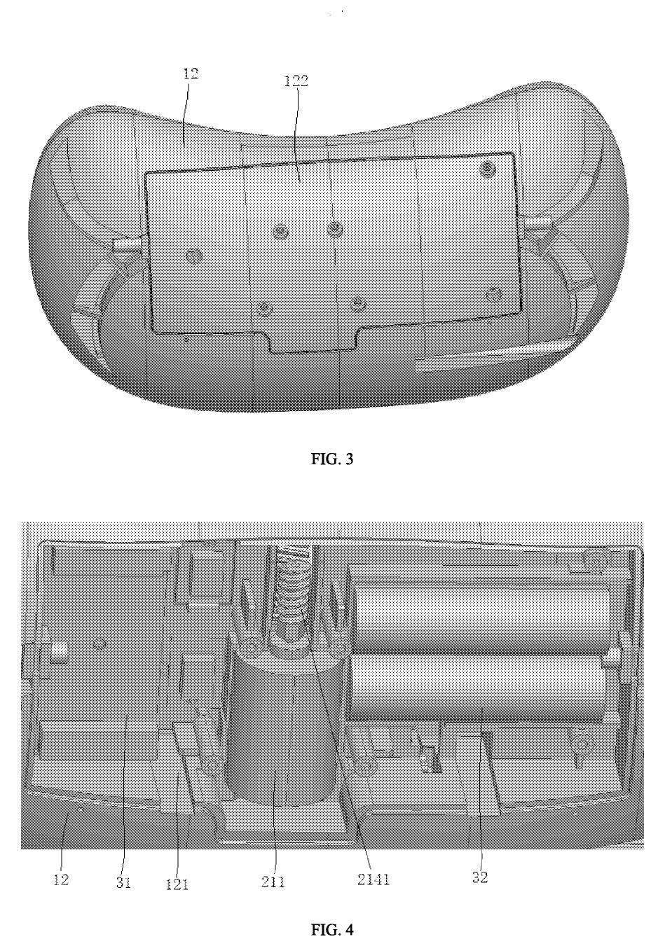

As shown in FIGS. 3 and 4, the massager further includes a control mechanism 3, and the control mechanism 3 includes a control main board 31, a battery 32, and a detection component. The control main board 31 and the battery 32 are provided inside the shell 1, and the control main board 31 is respectively connected to the massage mechanism with adjustment function 2, the battery 32, and the detection component for communication. The control main board 31 is configured to control and adjust a movement of the adjusting driving unit 211 based on a real-time detection of contact state information between the massage component 22 and a human body by the detection component, in order to adaptively adjust a position of the massage component 22. The state information obtained by the detection component is quickly processed by the control main board 31, and drives the adjusting driving unit 211 located in the same chamber to act, forming an efficient closed loop and improving the sensitivity and accuracy of adaptive adjustment.

In an implementation mode, the detection component includes a pressure sensor and a position sensor. The pressure sensor is provided on a surface of the massage head for contact with the human body to detect a pressure value exerted by the massage head on the human body, and the position sensor is configured to detect a real-time position of the push block 213.

The pressure sensor detects the pressure value applied by the massage head in real time and transmits it to the control main board 31. The position sensor detects the position of the push block 213 through a magnet, Hall sensor, or photoelectric encoder, reflecting a precise position of the massage component 22. The control main board 31 adjusts the position of the massage head in real-time according to the preset comfortable pressure range, and compares it with a target position to achieve high-precision closed-loop positioning.

In an implementation mode, the massage component 22 further includes a rotating joint connected to the massage head, and the detection component further includes an attitude sensor for detecting an angle of the massage head. When adjusting the positions of the two sets of massage components 22, the control main board 31 synchronously drives the rotating joint to adjust a pitch angle of the massage head, so as to better fit a human body curve.

The rotating joint is provided between the installation seat 221 and the massage head, and the rotating joint includes a fixed part, a rotating shaft, a movable part, and an angle driving unit. The fixed part is fixed to the installation seat 221, the movable part is fixed to the massage head, and the angle driving unit drives the movable part to swing. The attitude sensor detects the pitch angle of the massage head. The control main board 31 comprehensives the position and angle information, so that the massage head automatically adjusts a tilt angle after movement, thereby achieving three-dimensional adaptive fitting.

In an implementation mode, the detection component further includes a distance sensor for non-contact measurement of a distance between the massage head and a surface of the human body before it comes into contact with the human body.

The distance sensor is provided on or close to the massage head, which calculates a reflection time or a phase difference by emitting infrared, ultrasonic or laser signals, and real-time non-contact measurement of the distance between the massage head and the human body surface. Based on this, the system can achieve safety warning (slowing down or stopping when the distance is less than a threshold), intelligent initial positioning (scanning a contour to calculate an optimal contact point), and smooth contact guidance, improving safety and smoothness of fit.

The specific working principle and process of an adaptive adjustment of the massage machine are as follows:

### 1. Security scanning and intelligent prepositioning

1.1 Safety detection and slow approach: after a user wears the device and starts it, the control main board 31 first drives the adjustment component 21 to slowly move the massage head out of a storage position. During this process, the distance sensor continues to work, measuring a distance D_now to an object ahead in real-time. The system presets two thresholds, D_safe (e.g. 20mm) and D_stop (e.g. 10mm). When D_now ≤ D_safe, the massage head enters a slow approaching mode. When D_now ≤ D_stop, stop moving immediately to prevent collisions as the primary concern.

1.2 Contour learning and initial positioning: at a safe stopping point, the control main board 31 can instruct the massage head to perform a small range of lateral movement, and the distance sensor is configured to draw a contour curve of the human body surface distance. The algorithm analyzes the curve, intelligently identifies feature points (such as the highest point of the trapezius muscle), combines pre stored human models, calculates the optimal initial target position and estimated pitch angle, and drives the adjustment component 21 and the rotating joint to adjust the massage head to a prepared state. This step upgrades the positioning method from blind search to visual guidance.

### 2. Transition of contact and mode switching

2.1 Gentle contact and sensing handover: the massage head makes the final contact with the human body from a prepared state. During this journey, the distance sensor collaborates with the pressure sensor: when D_now approaches zero, the system prepares to switch. Once the pressure sensor detects that the pressure value P_now has jumped from zero (indicating contact), the control logic seamlessly switches from a “distance-based prediction mode” to a “pressure/angle based closed-loop fine-tuning mode”. The distance sensor can switch to low-power monitoring mode.

### 3. Real time monitoring and closed-loop fine-tuning

3.1 Real time multi-sensor monitoring: during a massage process, the system continuously monitors: pressure sensor feedback P_now, position sensor feedback L_now, and posture sensor feedback real-time angle θ _now of the massage head. At the same time, the distance sensor can be intermittently awakened to detect whether unexpected detachment (D_now suddenly increases) has occurred.

3.2 Data processing and dynamic decision-making: the control main board 31 compares P_now with a preset comfort pressure range [Pmin, P_max]: if P_now continues to be greater than P_max, the decision is to reduce the pressure (the massage head may massage too deeply). If P_now continues to be less than P_min, the decision is to increase pressure (the massage head may slip off). If P_now is within this range, maintain a current state. (Exception handling: if the distance sensor detects an unexpected detachment, the massage will be paused, and the repositioning process will be triggered).

### 3.3 Collaborative adjustment execution

Calculate a new target position L_target based on the decision. Send an instruction to adjust the adjusting driving unit 211 to drive the screw rod to rotate until the position sensor confirms reaching the L_target. At the same time, based on the feedback from the attitude sensor, θ _now is compared with the currently estimated optimal fitting angle θ _target to drive the rotating joint to adjust the tilt angle of the massage head and optimize the contact surface.

3.4 Closed loop feedback and continuous optimization: after the adjustment is completed, the pressure, position, and attitude sensors provide new data again, and the control main board 31 evaluates and decides whether to start a next round of adjustment. This cycle forms a dynamic closed loop, allowing the massage head to continuously track and conform to the curves of the human body, maintaining optimal pressure.

As shown in FIGS. 1 to 4, the shell 1 includes an upper shell 11 and a lower shell 12 that cooperate with each other. The lower shell 12 has an accommodation chamber 121 inside, and the massage component 22 is provided on the lower shell 12. The adjusting driving unit 211, the control main board 31, and the battery 32 are all provided in the accommodation chamber 121.

The upper shell 11 is detachably connected to the lower shell 12, and the accommodation chamber 121 is provided inside the lower shell 12. The upper shell 11 is provided with installation holes 111 at corresponding positions of the massage head, and the massage head passes through the installation holes 111 for massaging the human body. There is a mounting groove on the lower shell 12 for installing the adjusting screw rod 212, which limits a movement of the adjusting screw rod 212 and ensures its rotation. In an implementation mode, the upper shell 11 is provided with a motor heat dissipation hole 112 at a corresponding position of the rotating driving unit 231. The control main board 31, the battery 32, and the adjusting driving unit 211 are highly integrated into the same accommodation chamber 121, simplifying the structure, shortening an electrical path, improving assembly efficiency and reliability, and reducing energy transmission losses.

As shown in FIG. 2, the lower shell 12 is provided with maintenance cover 122 at a bottom of the accommodation chamber 121, and the maintenance cover 122 is provided with heat dissipation holes. The maintenance cover 122 can be disassembled to enclose the accommodation chamber 121, and it is densely provided with heat dissipation holes for easy maintenance and replacement of internal components, as well as facilitating air convection and heat dissipation.

In an implementation mode, the control mechanism 3 further includes a cooling fan provided in the accommodation chamber 121, the cooling fan is connected to the control main board 31. One or more cooling fans can be provided at the control main board 31 or arranged in a dispersed manner to enhance the heat dissipation capacity of the accommodation chamber 121, prevent electronic components from overheating, and ensure long-term stable operation.

In an implementation mode, the detection component further includes a temperature sensor, and the temperature sensor is provided inside the accommodation chamber 121. The control main board 31 is configured to detect a real-time temperature inside the accommodation chamber 121 based on the temperature sensor to control an operation of the cooling fan.

The temperature sensor monitors the temperature of the accommodation chamber 121, and the control main board 31 controls the fan according to the temperature value: it will turn off or slow down when it is below a first threshold (such as 40 ° C), medium speed when it is between first and second thresholds (such as 55 ° C), and full speed when it reaches or exceeds a third threshold (such as 65 ° C). If the temperature does not drop below the second threshold after running at full speed for 10 minutes, stop the massaging component 22. This strategy achieves intelligent temperature control, optimizing energy efficiency and noise.

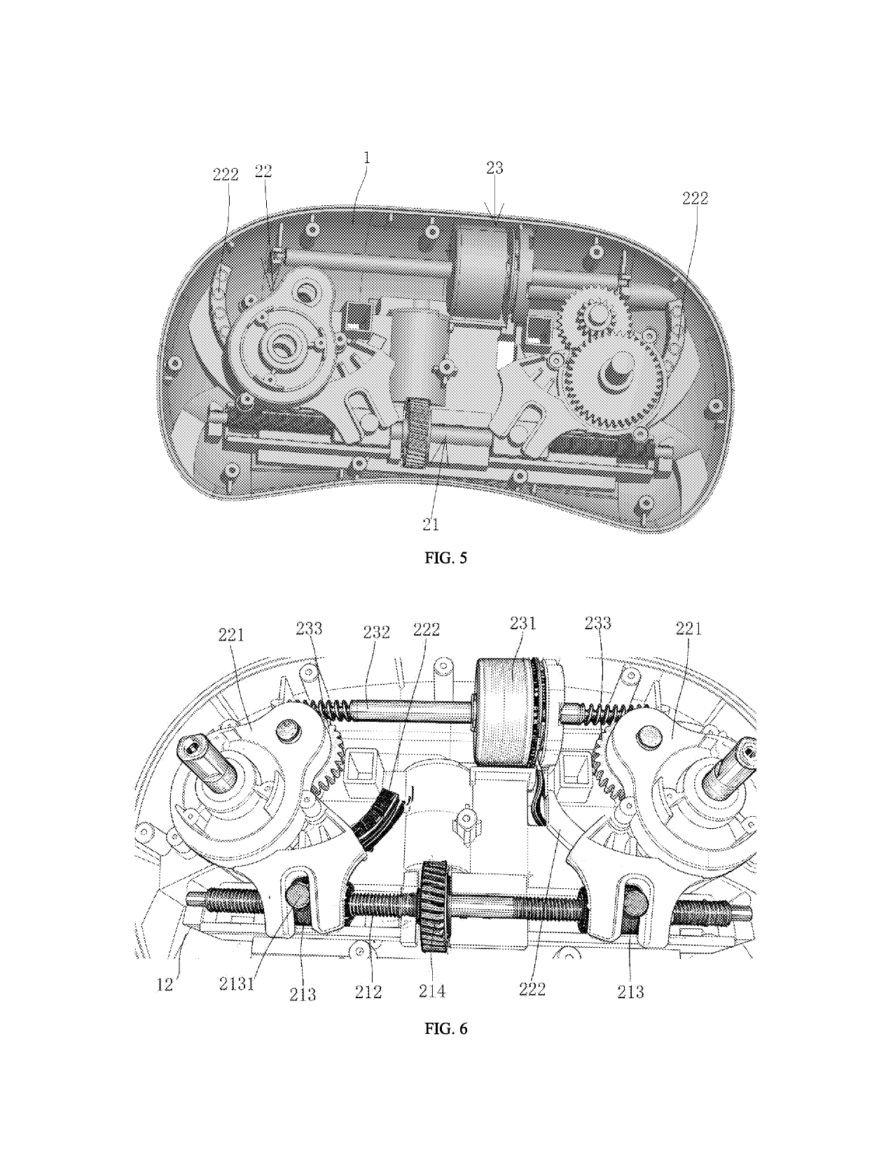

In an implementation mode, please refer to FIGS. 5 to 8. This embodiment also relates to a massage mechanism with adjustment function 2, which includes an adjustment component 21 and a massage component 22. The adjustment component 21 includes an adjusting driving unit 211, an adjusting screw rod 212, and at least one push block 213. An output shaft of the adjusting driving unit 211 is connected to the adjusting screw rod 212, and the push block 213 is threaded with the adjusting screw rod 212. The push block 213 is provided with a guide part 2131 on the push block 213. There are two or more sets of massage components 22. The massage components 22 include an installation seat 221 and a massage head provided on the installation seat 221. A sliding groove 2211 is provided on one side of the installation seat 221 close to the adjustment component 21. The sliding groove 2211 is inserted into the guide part 2131 and is slidably connected with the guide part 2131. Where the adjusting driving unit 211 drives the adjusting screw rod 212 to rotate, and the push block 213 pushes the installation seat 221 that is matched with the push block 213 to move so as to adjust a position of the massage component 22.

The adjusting driving unit 211 can be a micro stepper motor or a direct current, (DC) reduction motor, and the adjusting screw rod 212 is coaxially connected to its output shaft through a coupling. The guide part 2131 on the push block 213 has a T-shaped, circular, or rectangular cross-section.

The installation seat 221 is configured to carry the massage head, and a sliding groove 2211 is machined on one side close to the adjustment component 21. A shape of the sliding groove 2211 is complementary to the guide part 2131 on the push block 213. During assembly, the sliding groove 2211 is sleeved into the guide part 2131 to form a tight sliding fit. The massage head is rotatably provided on the installation seat 221, thereby providing actual massage contact.

The above technical solution drives the adjusting screw rod 212 to rotate by adjusting the adjusting driving unit 211, causing the push block 213 that is threaded with it to produce horizontal displacement. The guide part 2131 on the push block 213 slides and cooperates with the sliding groove 2211 of the installation seat 221, thereby directly converting a linear motion of the push block 213 into a precise translation of the massage component 22. The mechanical transmission principle not only achieves continuous and smooth electric adjustment of the massage head position, enabling it to quickly adapt to different user body types and massage parts, but also has a compact structure and reliable transmission, solving the problem of poor adjustment flexibility of traditional equipment.

As shown in FIGS. 5 and 6, the massage component 22 further includes a guide track 222, and the guide track 222 is arc shaped. The guide track 222 is configured for the installation seat 221 to slide, so that the installation seat 221 can adjust its position along the guide track 222.

A bottom of the installation seat 221 is provided with a slider or roller, which is embedded in the arc-shaped guide track 222. The installation seat 221 is hinged inside the shell 1, and one side cooperates with the adjustment component 21 through the sliding groove 2211. Under the action of the adjusting driving unit 211, it rotates around a hinge point and slides along the arc-shaped track, so that a trajectory of the massage head conforms to an ergonomic curve.

In this way, providing the arc-shaped guide track 222 not only plays a guiding role, but also enables the installation seat 221 to move along the arc-shaped trajectory, so that the massage head can better fit the physiological curves of the back, neck and other parts of the human body, thus providing a more comfortable massage experience.

As shown in FIGS. 5 to 7, the adjusting screw rod 212 is a bidirectional screw with threads at two ends that rotate in opposite directions. There are two push blocks 213 and two sets of massage components 22, with each set of massage components 22 corresponding to one push block 213. The two push blocks 213 are matched with threads at two ends of the bidirectional screw and are configured to move towards or away from each other when the adjusting screw rod 212 rotates, to synchronously drive the two sets of massage components 22 to approach or move away from each other.

When the adjusting driving unit 211 drives the adjusting screw rod 212 to rotate, due to an opposite thread direction at two ends, the two push blocks 213 will simultaneously move along an axial direction of the screw, and movement directions are opposite. When the adjusting screw rod 212 rotates in one direction, the two push blocks 213 move towards each other, the two sets of massage components 22 are driven to approach each other. On the contrary, when the adjusting screw rod 212 rotates in the opposite direction, the two push blocks 213 move backwards, driving the two sets of massage components 22 away from each other.

In this way, by using the bidirectional screw and two push blocks 213, the synchronous forward or reverse movement of two sets of massage components 22 can be achieved through a single adjusting driving unit 211. The structure is compact, the control is simple, and a distance between the two sets of massage heads can be accurately adjusted to adapt to different body characteristics such as shoulder width and back width of users.

In an implementation mode, two limit switches are included, and two limit switches correspond to limit travel positions of the two push blocks 213. The two limit switches are electrically connected to the control terminal of the adjusting driving unit 211. The control terminal can be the signal input terminal or power control terminal of the adjusting driving unit 211. When the limit switch is triggered, the power supply to the adjusting driving unit is cut off or a stop signal is sent through this control terminal.

During the adjustment process, when any push block 213 moves to the limit position and touches the corresponding limit switch, the limit switch will immediately send a signal to the adjusting driving unit 211. Cut off the power supply of the adjusting driving unit 211 or break it to force the movement to stop.

In this way, providing the limit switch effectively prevents the push block 213 from moving beyond a safe stroke, thereby avoiding mechanical overload or jamming, and improving the safety and reliability of the massage mechanism with adjustment function 2. When the push block 213 moves to the limit position, the limit switch is triggered, and the adjusting driving unit 211 stops working, thereby protecting the transmission components and motor.

In an implementation mode, the adjusting screw rod 212 is a unidirectional screw, and one push block 213 is provided. There are two sets of massage components 22, one set of massage components 22 is fixedly arranged, and the other set of massage components 22 cooperates with the push block 213 to adjust a distance between the two massage components 22.

The adjusting driving unit 211 drives the unidirectional screw to rotate, the only one push block 213 is driven to move linearly. The push block 213 drives the set of massage components 22 connected to it to move, thereby changing a distance between the movable massage component 22 and the fixed massage component 22.

In this way, the scheme of using the unidirectional screw rod with one single push block 213 has a simpler structure and lower cost, and is suitable for application scenarios with relatively low requirements for adjustment accuracy or cost sensitivity. A fixed set of massage components 22 serves as a reference, while moving another set of massage components 22 achieves spacing adjustment, still meeting basic adjustment requirements.

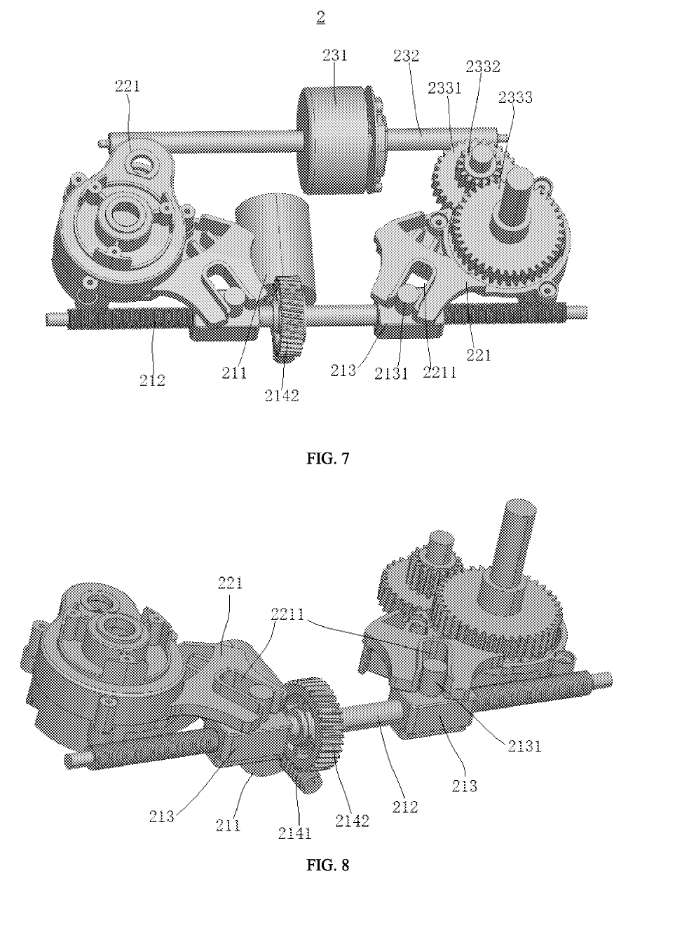

As shown in FIGS. 7 and 8, an output shaft of the adjusting driving unit 211 is connected to the adjusting screw rod 212 through a worm gear transmission component 214. The worm gear transmission component 214 includes a worm shaft 2141 and a worm wheel 2142. The worm shaft 2141 is connected to an output shaft of the adjusting driving unit 211, and the worm wheel 2142 is fixedly sleeved on the adjusting screw rod 212 and meshes with the worm shaft 2141. Where, the adjusting driving unit 211 drives the worm shaft 2141 to rotate and the worm wheel 2142 to rotate, thereby driving the adjusting screw rod 212 to rotate.

In this embodiment, the adjusting driving unit 211 cooperates with the massage component 22 through the adjusting screw rod 212 and the push block 213. In an implementation mode, an output shaft of the adjusting driving unit 211 can also be connected to a pinion, and a rack meshed with the pinion is fixedly connected with the installation seat 221. The driving unit drives the gears in both forward and reverse directions to drive the rack and installation seat 221 to perform linear reciprocating motion. Or the output shaft of the adjusting driving unit 211 can be connected to the pinion, and the rack that meshes with the pinion can be fixedly connected to the installation seat 221. The driving unit drives the gears in both forward and reverse directions to drive the rack and installation seat 221 to perform linear reciprocating motion.

In this way, the worm gear transmission component 214 has the advantages of smooth transmission, low noise, and large transmission ratio. It can convert a high-speed low torque output of the adjusting driving unit 211 into a low-speed high torque rotation of the adjusting screw rod 212, improving the smoothness and accuracy of adjustment. At the same time, the worm gear transmission has a reverse self-locking characteristic, which can effectively prevent the adjusting screw rod 212 from reversing due to external forces after the adjusting driving unit 211 stops, ensuring the stable position of the massage component 22.

As shown in FIGS. 5 to 7, the massage mechanism with adjustment function further includes a rotating component 23. The rotating component 23 includes a rotating driving unit 231 and a rotating screw rod 232. An output shaft of the rotating driving unit 231 is connected to the rotating screw rod 232. There are two sets of massage components 22, and the two ends of the rotating screw rod 232 are respectively connected to the two sets of massage heads for transmission; where the rotating driving unit 231 drives the rotating screw rod 232 to rotate, to cause the two sets of massage heads to rotate.

The installation seat 221 is hinged and provided inside the shell 1 on the other side away from the adjustment component 21. The rotating component 23 can be an existing rotating structure. In this embodiment, a rotation of the rotating screw rod 232 is transmitted to two massage heads through a transmission mechanism (such as a walking belt, a connection rod, or a gear), driving them to perform synchronous rotational massage actions (such as kneading, finger pressing). The position adjustment and rotation functions are independent of each other, driven by different motors, and can work separately or in combination.

In this way, providing the rotating component 23 enables the massage head to not only adjust its position but also its rotation angle, achieving multi degree of freedom massage. The rotating massage head can simulate hand kneading, massage and other movements, providing richer massage techniques and better massage effects, meeting users’ needs for different massage methods.

As shown in FIG. 7, the two ends of the rotating screw rod 232 are connected to the massage head through the gear transmission component 233. The gear transmission component 233 includes a first gear 2331, a second gear 2332, and a third gear 2333. The first gear 2331 meshes with the rotating screw rod 232, the second gear 2332 is coaxially provided with the first gear 2331, the third gear 2333 is coaxially provided with the massage head on the installation seat 221, and the third gear 2333 meshes with the second gear 2332. Where when the rotating screw rod 232 rotates, it drives the first gear 2331 to rotate, which in turn drives the massage head to rotate through the second gear 2332 and the third gear 2333.

The first gear 2331 is coaxially arranged with a hinge shaft of the installation seat 221 (which hinges the installation seat 221 inside the shell 1). In an implementation mode, a diameter of the first gear 2331 is greater than a diameter of the second gear 2332, and a diameter of the third gear 2333 is greater than the diameter of the first gear 2331. The first gear 2331 with a large diameter meshes with the rotating screw rod 232, forming a first stage of deceleration (input speed decreases, torque initially increases). Next, the second gear 2332, which is coaxial with the first gear 2331 and has a small diameter, rotates synchronously and drives the third gear 2333, which has a large diameter. This constitutes a second stage deceleration (the speed is further significantly reduced, and the torque is greatly enhanced). After these two stages of deceleration, a final output speed to the massage head is reduced to a low-speed range suitable for massage (simulating gentle hand kneading), and an output torque is amplified several times. This allows the massage head to maintain stable and powerful rotation even when subjected to resistance from human tissue, ensuring the depth and stability of the massage effect.

In this way, the design of the gear transmission component 233 realizes a conversion of a rotational motion of the rotating screw rod 232 to a rotational motion of the massage head, with high transmission efficiency and compact structure. Through multi-stage gear transmission, the speed can be appropriately reduced, and the torque can be increased to provide sufficient massage force to the massage head. At the same time, the gear transmission has high precision and can achieve precise control of a rotation angle of the massage head.

The working principle of massage mechanism with adjustment function 2 is as follows.

When it is necessary to adjust the position of the massage head, the control main board 31 sends a control instruction to the adjusting driving unit 211. The adjusting driving unit 211 is started, and the adjusting screw rod 212 is drived to rotate through the worm gear transmission component 214. Due to the push block 213 being limited within the sliding groove 2211 of the installation seat 221 by the guide part 2131, under the drive of the thread, the push block 213 can only make precise linear motion along the axis of the adjusting screw rod 212. When the push block 213 moves, the side of its guide part 2131 contacts an inner wall of the sliding groove 2211 and generates thrust or tension, thereby directly driving the installation seat 221 and the massage head to move along the guide track 222, thereby achieving continuous and smooth adjustment of the position.

When a rotary massage function needs to be activated, the control main board 31 sends the control instructions to the rotating driving unit 231. The rotating driving unit 231 is activated, the rotating screw rod 232 is driven to rotate. The rotating screw rod 232 transmits a rotational motion to two sets of massage heads through the gear transmission component 233, the massage heads are caused to rotate synchronously and achieve massage actions such as kneading and finger pressure.

During the adjustment process, when any push block 213 moves to the limit position and touches the limit switch, the limit switch sends a signal to the control main board 31, which immediately cuts off the power supply of the adjusting driving unit 211 or breaks it, forcing the movement to stop and preventing mechanical overload or jamming.

The control main board 31 can receive user button commands or application, (APP) commands (such as “increase spacing”, “start kneading”), and automatically coordinate and control the start stop, steering, and speed of the adjusting driving unit 211 and the rotating driving unit 231 according to a preset program, achieving intelligent adjustment of the position and rotation angle of the massage head. The user can select different massage modes through a simple operation interface, and the control main board 31 automatically executes the corresponding adjustment program, thereby providing a personalized massage experience.

What is claimed is:

1. A massage mechanism with adjustment function, comprising:
an adjustment component, which comprises an adjusting driving unit, an adjusting screw rod, and at least one push block, wherein an output shaft of the adjusting driving unit is connected to the adjusting screw rod, the push block is threaded with the adjusting screw rod, and a guide part is provided on the push block; and
two sets of massage components, wherein the massage components comprise an installation seat and a massage head provided on the installation seat, a sliding groove is provided on one side of the installation seat close to the adjustment component, and the sliding groove is inserted into the guide part and slidably connected with the guide part;
wherein the adjusting driving unit drives the adjusting screw rod to rotate, and the push block pushes the installation seat that cooperates with it to move and adjust a position of the massage component.

2. The massage mechanism with adjustment function according to claim 1, wherein the massage component further comprises a guide track, the guide track is arc-shaped, and the guide track is configured for the installation seat to slide and adjust a position of the installation seat along the guide track.

3. The massage mechanism with adjustment function according to claim 1, wherein the adjusting screw rod is a bidirectional screw, and two ends of the adjusting screw rod have threads with opposite rotation directions;
there are two sets of push blocks, and there are two sets of massage components, each set of massage components corresponds to one push block;
the two push blocks are matched with the threads at two ends of the bidirectional screw and are configured to move towards or away from each other when the adjusting screw rod rotates and synchronously drive the two sets of massage components to approach or move away from each other.

4. The massage mechanism with adjustment function according to claim 3, further comprising two limit switches, the two limit switches are arranged corresponding to limit stroke positions of the two push blocks, and the two limit switches are electrically connected to a control terminal of the adjusting driving unit.

5. The massage mechanism with adjustment function according to claim 1, wherein the adjusting screw rod is a unidirectional screw, and there is one push block;
there are two sets of massage components, one set of massage components is fixedly arranged, and the other set of massage components cooperates with the push block to adjust a distance between the two massage components.

6. The massage mechanism with adjustment function according to claim 1, wherein the output shaft of the adjusting driving unit is connected to the adjusting screw rod through a worm gear transmission component, and the worm gear transmission component comprises a worm shaft and a worm wheel,
the worm shaft is connected to the output shaft of the adjusting driving unit, the worm wheel is fixedly sleeved on the adjusting screw rod and meshes with the worm shaft;
wherein the adjusting driving unit drives the worm shaft to rotate, drives the worm wheel to rotate, and thus drives the adjusting screw rod to rotate.

7. The massage mechanism with adjustment function according to claim 1, further comprising a rotating component,
wherein the rotating component comprises a rotating driving unit and a rotating screw rod, an output shaft of the rotating driving unit is connected to the rotating screw rod, there are two sets of massage components, and two ends of the rotating screw rod are respectively connected to the two sets of massage heads for transmission;
wherein the rotating driving unit drives the rotating screw rod to rotate and cause the two sets of massage heads to rotate.

8. The massage mechanism with adjustment function according to claim 7, wherein the two ends of the rotating screw rod are connected to the massage head through a gear transmission component, and the gear transmission component comprises a first gear, a second gear, and a third gear;
the first gear meshes with the rotating screw rod, the second gear is coaxially arranged with the first gear, the third gear is coaxially arranged with the massage head on the installation seat, and the third gear meshes with the second gear;
wherein when the rotating screw rod rotates, it drives the first gear to rotate and drive the massage head to rotate through the second gear and the third gear.

9. A massager, comprising:
a shell; and
the massage mechanism with adjustment function according to claim 8, wherein the massage mechanism with adjustment function is provided inside the shell.

10. The massager according to claim 9, wherein the massager further comprises a control mechanism, and the control mechanism comprises a control main board, a battery, and a detection component;
the control main board and the battery are provided in the shell, and the control main board is respectively connected to the massage mechanism with adjustment function, the battery, and the detection component for communication;
the control main board is configured to control a movement of the adjusting driving unit based on a real-time detection of contact state information between the massage component and a human body by the detection component to adaptively adjust a position of the massage component.

11. The massager according to claim 10, wherein the detection component comprises a pressure sensor and a position sensor,
wherein the pressure sensor is provided on a surface of the massage head for contact with the human body, and configured to detect a pressure value exerted by the massage head on the human body, and
the position sensor is configured to detect a real-time position of the push block.

12. The massager according to claim 10, wherein the massage component further comprises a rotating joint connected to the massage head, the detection component further comprises an attitude sensor configured to detect an angle of the massage head, and the control main board synchronously drives the rotating joint to adjust a pitch angle of the massage head when adjusting positions of the two sets of massage components, so as to fit a human body curve.

13. The massager according to claim 10, wherein the detection component further comprises a distance sensor for non-contact measurement of a distance between the massage head and a surface of the human body before the massage head contacts the human body.

14. The massager according to claim 10, wherein the shell comprises an upper shell and a lower shell that are matched with each other,
the lower shell is provided with an accommodation chamber inside, the massage component is provided on the lower shell, and the adjusting driving unit, the control main board, and the battery are all provided in the accommodation chamber.

15. The massager according to claim 14, wherein the lower shell is provided with a maintenance cover at a bottom of the accommodation chamber, and the maintenance cover is provided with a heat dissipation hole.

16. The massager according to claim 15, wherein the control mechanism further comprises a heat dissipation fan provided in the accommodation chamber, and the heat dissipation fan is connected to the control main board.

17. The massager according to claim 16, wherein the detection component further comprises a temperature sensor, and the temperature sensor is provided in the accommodation chamber, wherein the control main board is configured to detect a real-time temperature inside the accommodation chamber based on the temperature sensor to control an operation of the cooling fan.
